(19) United States
(12) Patent Application Publication
(10) Pub. No.: US 2019/0080356 A1
(43) Pub. Date: Mar. 14, 2019

(54) ADVERTISEMENT SYSTEM FOR VEHICLE AND ADVERTISEMENT METHOD USING THE SAME

(71) Applicants: Hyundai Motor Company, Seoul (KR); Kia Motors Corporation, Seoul (KR)

(72) Inventors: Ji Min Han, Anyang (KR); Jung Mi Park, Anyang (KR); Ji A Lee, Uiwang (KR)

(21) Appl. No.: 15/858,866

(22) Filed: Dec. 29, 2017

(30) Foreign Application Priority Data
Sep. 11, 2017 (KR) 10-2017-0115829

(51) Int. Cl. G06Q 30/02; H04H 60/31

(52) U.S. Cl. CPC G06Q 30/0265; G06Q 30/0207; G06Q 2240/00; G06Q 30/0275; H04H 60/31

(57) ABSTRACT

An advertisement system using a vehicle and an advertisement method using the same are provided. The advertisement system includes an advertisement server that stores advertisement contents regarding a plurality of advertisers and at least one advertisement playback unit that is mounted to a vehicle and plays back the advertisement contents. An advertisement controller receives the advertisement contents from the advertisement server by communicating with the advertisement server and controls the received advertisement contents to be played back through the advertisement playback unit. When parking the vehicle, the advertisement contents supplied from the advertisement server are played back through the advertisement playback unit mounted to the vehicle.

### CROSS REFERENCE TO RELATED APPLICATION(S)

This application claims the benefit of Korean Patent Application No. 10-2017-0115829, filed on Sep. 11, 2017, which is hereby incorporated by reference as if fully set forth herein.

### BACKGROUND

### Field of the Invention

The present invention relates to a vehicle, and more particularly to a vehicle application technology that utilizes a vehicle for advertisement purposes while the vehicle is not in motion.

### Discussion of the Related Art

Generally, locations such as large department stores, shopping centers, theaters, and sports stadiums are difficult for vehicle parking due to the substantial number of people at such locations. Therefore, large parking lots or parking garages (hereinafter referred to as parking lots) are constructed in regions with heavy traffic to facilitate the parking availability problem. When a user of a parked vehicle intends to exit a parking lot in which the vehicle is parked, the user pays a parking fee calculated based on a total parking time of the vehicle, and payment of the parking fee is typically made at an exit of the parking lot.

Although the vehicle is capable of traveling a substantial distance and provides the user of the vehicle with many conveniences, the user is required to pay the parking fee whenever using the parking lot. The parking fee also increases as the parking time increases. Thus, a user who frequently uses the parking lot may be dissatisfied with the finances related to such parking fees.

### SUMMARY

Accordingly, the present invention provides an advertisement system using a vehicle and an advertisement method using the same that substantially obviate one or more problems due to limitations and disadvantages of the related art. An object of the present invention is to provide an advertisement system using a vehicle, which uses the vehicle for driving purposes and also for other purposes capable of creating economic benefits, and an advertisement method using the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an advertisement system using a vehicle may include an advertisement server configured to store advertisement contents regarding a plurality of advertisers, at least one advertisement playback unit mounted to an exterior of a vehicle, configured to play back the advertisement contents, and an advertisement controller configured to receive the advertisement contents from the advertisement server by communicating with the advertisement server, and control the received advertisement contents to be played back through the advertisement playback unit. When parking of the vehicle, the advertisement contents supplied from the advertisement server may be played back through the advertisement playback unit mounted to the vehicle based on a particular selection.

The advertisement server may include a database (DB) configured to store the advertisement contents, an advertisement selection unit configured to select some advertisement contents from among the advertisement contents stored in the database (DB), and an advertisement transceiver configured to transmit the advertisement contents selected by the advertisement selection unit by communicating with the advertisement controller.

The advertisement server may further include a fee calculation unit configured to calculate a fee for the advertisement contents transmitted by the advertisement transceiver. In particular, the fee calculation unit may be configured to calculate a usage fee of the advertisement contents and pay the calculated usage fee as a parking fee of the vehicle when the vehicle arrives at an exit of a parking region. The fee calculation unit may further be configured to calculate a usage fee of the advertisement contents and pay the calculated usage fee to a vehicle owner.

Further, the advertisement selection unit may be configured to select, from among a plurality of advertisement contents allocated according to peripheral environment characteristics and advertisement demand class information, a few advertisement contents allocated to a region in which the parked vehicle is located, and may be configured to transmit the selected advertisement contents to the advertisement transceiver. The advertisement selection unit may be configured to select at least one of the advertisement playback units to be used for playback of the selected advertisement contents and transmit information that indicates the selected advertisement playback unit to the advertisement transceiver.

The advertisement playback unit may include at least one of a display, a light, and a speaker installed inside or outside of the vehicle. The display may be mounted to at least one of a sunroof, a sun visor, an audio video navigation (AVN), a cluster, a windshield, a door, and a window of the vehicle. The advertisers may provide the advertisement server with advertisement contents using a bidding system, and may receive advertisement contents classified according to individual regions and peripheral environment characteristics. The advertisement controller may then be configured to transmit vehicle status information, which includes at least one of a current position of the vehicle, peripheral point of interest (POI) information, peripheral vehicle information, a current time, a battery charge, and an estimated re-driving time, to the advertisement server. However, the present invention is not limited to the about vehicle status information and the other known vehicle status information may be transmitted to the advertisement server.

In accordance with another aspect of the present invention, an advertisement method using a vehicle may include parking the vehicle, selecting whether to play back advertisement, when the playback of the advertisement is selected, transmitting status information of the vehicle to an advertisement server, transmitting the advertisement stored in the advertisement server to the vehicle, and playing back the advertisement through the vehicle. The status information of the vehicle may include at least one of a current position of the vehicle, peripheral POI information, peripheral vehicle information, a current time, a battery charge, and an estimated re-driving time of the vehicle. The advertisement method may further include, after parking the vehicle, determining whether the parked vehicle is in an advertisement available state in which the advertisement is executable through the parked vehicle.

The determination of whether the parked vehicle is in the advertisement available state may include determining that the parked vehicle is in the advertisement available state when the vehicle is in at least one of a first state in which a gearshift lever of the vehicle is located in a parking mode (P) and a second state in which the vehicle stops for a predetermined period of time or longer. The advertisement method may further include, before transmitting the advertisement to the vehicle, selecting advertisement to be transmitted from the advertisement server to the vehicle.

The advertisement method may further include, after selecting the advertisement, calculating a usage fee of the advertisement. The playing back of the advertisement through the vehicle may include playing back the advertisement through at least one of a display, a light, and a speaker installed inside or outside of the vehicle. The advertisement server may include advertisement contents supplied from a plurality of advertisers.

The selecting of the advertisement to be transmitted from the advertisement server to the vehicle may include selecting, from among the advertisement contents supplied from a plurality of advertisers, a few advertisement contents allocated to a region in which the parked vehicle is located. The advertisers may provide the advertisement server with advertisement contents using a bidding system and may receive advertisement contents allocated for each region according to peripheral environment characteristics and advertisement demand class information. The advertisement method may further include, after playing back the advertisement through the vehicle, paying an advertisement usage fee caused by playback of the advertisement to an owner of the vehicle. The advertisement usage fee may be used as a parking fee of the vehicle.

In accordance with another aspect of the present invention, an advertisement method using a vehicle may include dividing a region to be used for advertisement in a parking state of the vehicle into a plurality of sub-regions, allowing a plurality of advertisers to participate in auction bidding for advertisement based on the respective sub-regions, allocating advertisement contents classified according to the respective sub-regions and peripheral environment characteristics to advertisers acting as successful bidders, storing successfully sold advertisement contents in an advertisement server, when playback of the advertisement is selected, selecting advertisement contents based on parking sub-regions in which the vehicle is parked, selecting an advertisement playback unit of the vehicle, transmitting the selected advertisement contents to the vehicle, and playing back the transmitted advertisement contents through the vehicle, and when the playback of the advertisement is completed, calculating a usage fee of the advertisement, and paying a parking fee of the vehicle using the advertisement usage fee when the vehicle arrives at an exit of the parked region.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate exemplary embodiment(s) of the invention and together with the description serve to explain the principle of the invention. In the drawings:

FIG. 1 is a block diagram illustrating an advertisement system using a vehicle according to an exemplary embodiment of the present invention;

FIG. 2 is a flowchart illustrating an advertisement method using a vehicle according to a first exemplary embodiment of the present invention;

FIG. 3 is a view illustrating arrangement of advertisement contents based on individual zones of a parking lot according to an exemplary embodiment of the present invention;

FIG. 4 is a flowchart illustrating an advertisement method using a vehicle according to a second exemplary embodiment of the present invention;

FIG. 5 is a flowchart illustrating an advertisement method using a vehicle according to a third exemplary embodiment of the present invention; and

FIG. 6 is a flowchart illustrating an advertisement method using a vehicle according to a fourth exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, the exemplary embodiments will be clearly appreciated through the accompanying drawings and the following description thereof. In the drawings, sizes and shapes of elements may be exaggerated, omitted or schematically illustrated for clarity and convenience. In addition, the size of each constituent element does not wholly reflect an actual size thereof. In addition, the same reference numerals designate the same constituent elements throughout the description of the drawings.

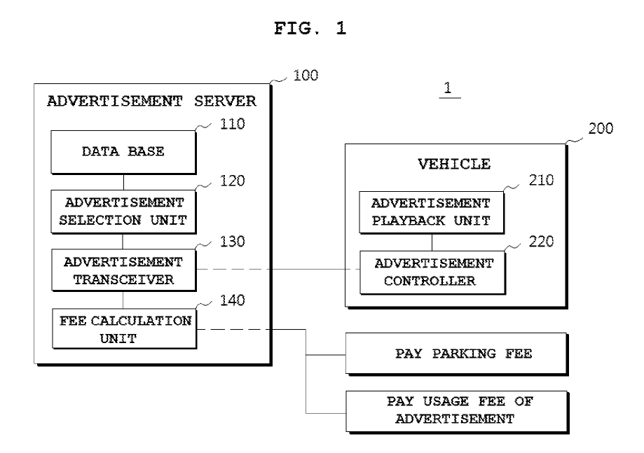

FIG. 1 is a block diagram illustrating an advertisement system 1 using a vehicle according to an exemplary embodiment of the present invention. Referring to FIG. 1, the advertisement system 1 may include an advertisement server 100 and a vehicle 200 that are configured to communicate with other. The vehicle 200 may specifically include a controller configured to communicate with the advertisement server 100 via a known method of communication. Additionally, the vehicle 200 and the advertisement server 100 may each include a controller having a memory and a processor.

In particular, the advertisement server 100 may be configured to store advertisement contents supplied from a plurality of advertisers and provide the vehicle 200 with advertisement contents by communicating with the vehicle 200 parked in a parking lot. The advertisement server 100 may include a database (DB) in which advertisement contents may be stored, an advertisement selection unit 120 configured to store the advertisement contents stored in the database (DB) 110, an advertisement transceiver 130 configured to receive vehicle status information from the vehicle 200 by communicating with the vehicle 200 and transmit advertisement contents selected by the advertisement selection unit 120 to the vehicle 200, and a fee calculation unit 140 configured to calculate a fee for the advertisement contents transmitted to the vehicle 200.

The advertisement selection unit 120 may be configured to transmit advertisement contents selected from among the advertisement contents allocated according to individual regions in which the vehicle 200 is parked and peripheral environment characteristics of the parked vehicle 200, to the advertisement transceiver 130. Accordingly, the selected advertisement contents may be transmitted to the vehicle 200. The advertisers may provide the advertisement server 100 with advertisement contents using a bidding system and advertisement contents selected according to individual regions or peripheral environment characteristics may be allocated to the advertisers. A detailed description thereof will be herein below.

The vehicle 200 may include an advertisement playback unit 210 configured to play back (e.g., output) advertisement contents received from the advertisement server 100, and an advertisement controller 220 configured to operate the advertisement playback unit 210 by communicating with the advertisement server 100. The advertisement playback unit 210 may include at least one of a display, light(s), and speaker(s) mounted inside or outside of the vehicle 200. For example, the display may be mounted to at least one of a sunroof, a sun visor, an audio video navigation (AVN), a cluster, door(s), window(s), and a rear window.

The sunroof may form an opening at a roof of the vehicle 200 for convenience of a driver of the vehicle 200, and may include a panel configured to open or close the opening. The display may be mounted to the panel of the sunroof. In particular, the display may be used as the advertisement playback unit 210. The sun visor may include a sun cover, mounted to an upper part of a front window (hereinafter referred to as a windshield) located near a driver seat and a passenger seat and may be selectively opened or closed to block the sunlight. The display may be mounted to the sun visor. In particular, the display mounted to the sun visor may be used as the advertisement playback unit 210. The scope or spirit of the advertisement playback unit 210 is not limited thereto, and may include various types of devices configured to communicate with an external part to allow information and signals to be exchanged between each of the devices and the external part.

The AVN may also be referred to as an AVN terminal, and may be embedded in the vehicle 200 to provide audio, video, and navigation functions. The AVN may be configured to communicate with a telematics server and the AVN may be configured to transmit and receive various types of information to and from the telematics server. The AVN may include a display to visually provide the user with necessary information. The display mounted to the AVN may be used as the advertisement playback unit 210. In particular, the AVN display may provide various functions, for example, a navigation function that provides a navigation route to a point of interest (POI) selected or input by the user.

The windshield may be mounted to a front or rear window of the vehicle 200, and may include a display. In particular, the windshield having the display may also be used as the advertisement playback unit 210. The displays mounted to the sunroof, the sun visor, the AVN, and the windshield are disclosed only for illustrative purposes. The scope and spirit of the displays are not limited thereto, and various types of display devices mounted inside or outside of the vehicle 200 to perform visual advertisement may be used as the advertisement playback unit 210 of this exemplary embodiment. The lights may refer to various types of lights including headlights, taillights, and emergency lights, and may be used for advertisement using the change of lighting color and light flashing (or blinking) actions, etc. In other words, various lighting actions may be indicative of particular advertisement. The speaker mounted inside or outside of the vehicle may include a horn or other types of speakers capable of audibly providing advertisement.

The advertisement controller 220 may be configured to receive advertisement contents from the advertisement server 100 by communicating with the advertisement transceiver 130 of the advertisement server 100 and play back (e.g., output) the received advertisement contents through the advertisement playback unit 210. Therefore, when parking the vehicle 200, advertisement contents selectively supplied from the advertisement server 100 may be played back through the advertisement playback unit 210 of the vehicle 200.

Particularly, the advertisement controller 220 may be configured to transmit status information of the vehicle 200. The status information of the vehicle 200 may include at least one of a current position of the vehicle 200, peripheral POI information, peripheral vehicle information (e.g., information regarding whether the peripheral vehicle participates in advertisement), a current time, a battery charge, and an estimated re-driving time of the vehicle 200 (e.g., when the vehicle will be driven next or again). The status information of the vehicle 200 may be used to determine the category of advertisement contents to be supplied to the vehicle 200, as well as to calculate a usage fee of the advertisement contents.

The vehicle status information supplied to the advertisement server 100 may then be used by the advertisement server 100 to select advertisement contents to be allocated to a parking region of the vehicle 200 and the advertisement server 100 may be configured to calculate a usage fee of the advertisement. The fee calculation unit 140 of the advertisement server 100 may be configured to calculate the usage fee of the advertisement and use the calculated advertisement usage fee as the parking fee of the vehicle 200 having been used for the advertisement when the vehicle 200 arrives at an exit of the parking region or may be configured to transmit the calculated advertisement usage fee to a pre-registered account of an owner (or user) of the vehicle 200. In particular, the advertisement usage fee may be accumulated as points and the accumulated points may also be used as a payment method for paying the parking fee, prices of articles (e.g., consumer goods), etc.

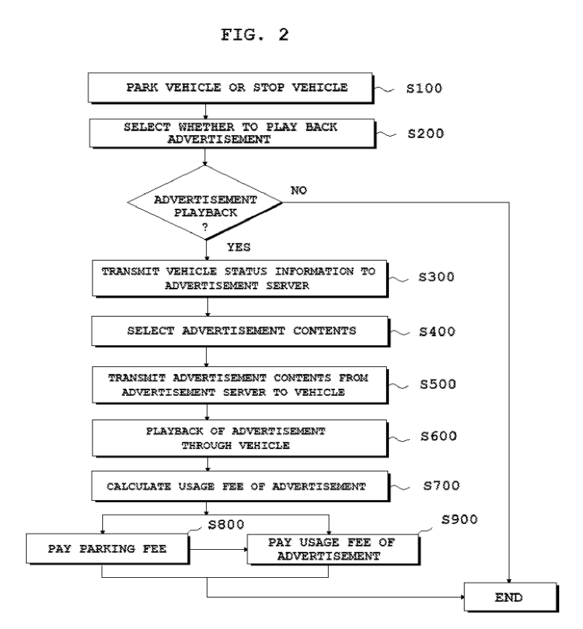

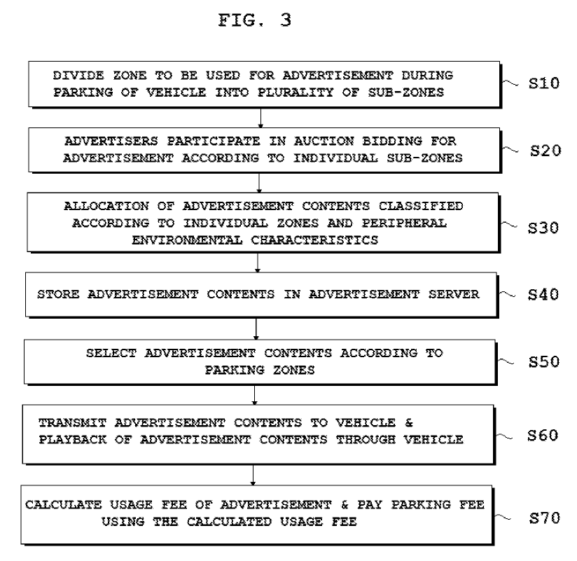

FIG. 2 is a flowchart illustrating an advertisement method using a vehicle according to a first exemplary embodiment of the present invention. FIG. 3 is a view illustrating arrangement of advertisement contents based on individual zones of a parking lot. The method to be described herein below may be executed by a controller mounted within the vehicle.

Referring to FIG. 2, an advertisement method using a vehicle 2 according to the first exemplary embodiment of the present invention may include allowing a user to park the vehicle 2 in a parking lot (S100). In particular, the vehicle 2 may include a vehicle of the user, shared vehicles, and vehicles for business purposes. The parking state of the vehicle 200 may indicate that the vehicle 200 is turned off and remains in the parking lot for a substantial period of time during which the vehicle may be used for advertisement purposes. When necessary, the parking state of the vehicle 200 may further include a temporary stop state in which the vehicle 200 stops at a current position for a predetermined time or longer without being powered off.

After parking of the vehicle 200, the user (driver) of the vehicle 200 may select whether to play back advertisement contents (S200). For example, information regarding whether the advertisement contents will be played back may be selected through an icon or the like of the AVN display. In particular, the driver of the vehicle 200 may receive the above information related to playback of the advertisement contents in response to the vehicle 200 being parked in the parking lot, or the user may manually select or set an advertisement mode. When the driver or user of the vehicle 200 selects the advertisement mode, status information of the vehicle 200 may be transmitted to the advertisement server 100 (S300). When the driver or user of the vehicle 200 does not select the advertisement mode, the vehicle 200 is not used for advertisement and remains parked in the parking lot.

The status information of the vehicle 200 may include at least one of a current position, peripheral POI information, peripheral vehicle information, a current time, a battery charge, and an estimated re-driving time of the vehicle 200. As described above, the status information of the vehicle 200 may be used to determine the category of advertisement contents to be supplied to the vehicle 200, as well as to calculate a usage fee of the advertisement contents. The step S300 of transmitting the vehicle status information may use the above-mentioned advertisement system 1, such that the status information of the vehicle 200 may be transmitted from the advertisement controller 220 to the advertisement transceiver 130.

Upon completion of the step S300, the advertisement server 100 may be configured to select advertisement contents to be transmitted to the vehicle 200 (S400). In step S400, the advertisement contents to be transmitted to the vehicle 200 may be selected from among a plurality of advertisement contents allocated based on individual regions including the parked vehicle 200 and peripheral environment characteristics of the parked vehicle 200.

The advertisement server 100 of the above-mentioned advertisement system 1 may include advertisement contents supplied from the plurality of advertisers. In particular, the advertisers may provide the database (DB) 110 of the advertisement server 100 with advertisement contents using the bidding system, and advertisement contents selected and classified according to individual regions, peripheral environment characteristics, and advertisement demand classes may be allocated to the advertisers.

Priority information of the individual regions and the peripheral environment characteristics may be, for example, when the parking lot of the vehicle 200 is located in the vicinity of a movie theater, advertisement contents associated with newly released films. In addition, when the parking lot of the vehicle 200 is located in the vicinity of a baseball stadium, priority information may be, for example, chicken and beer advertisement contents. Priority information of the advertisement demand class (advertisement target class) may be, for example, when the parking lot of the vehicle 200 is located in vicinity of schools or private educational institutes, advertisement contents associated with school supplies, books, etc. An advertisement agency company for operating and managing the advertisement server 100 may update information regarding advertisement-available parking regions and associated advertisement contents, may provide the updated information to advertisers, and may thus guide the advertisers to participate in bidding for advertisement.

Referring to FIG. 3, for example, to guide the advertisers to participate in bidding for advertisement contents in a parking lot located in a zone A (hereinafter referred to as a parking zone A), the advertisement server 100 may be configured to divide the parking zone A into a plurality of sub-zones A-1 to A-8, provide the advertisers with information for each sub-zone, and guide the advertisers to participate in auction bidding for advertisement. In particular, several advertisers may participate in bidding for advertisement in desired parking sub-zones. Various advertisement contents may be allocated to the respective parking sub-zones according to the above-mentioned regional and peripheral environmental characteristics, advertisement demand classes, bidding prices, etc.

For example, as shown in FIG. 3, hamburger advertisement contents of a first advertiser (1) may be allocated to the parking sub-zones A-1 to A-4, sport-shoes advertisement contents of a second advertiser (2) may be allocated to the parking sub-zones A-5 to A-7, and beverage advertisement contents of a third advertiser (3) may be allocated to the parking zone A-8. In the step S400 for selecting the advertisement contents, the advertisement server 100 may be configured to recognize vehicle status information such as a current position of the parked vehicle 200, to allow the advertisement selection unit 120 of the advertisement server 100 to select the advertisement contents from among all the advertisement contents stored in the database (DB) 110 and the advertisement server 100 may be configured to transmit the selected advertisement contents to the vehicle 200 using the advertisement transceiver 130.

When the advertisement contents stored in the advertisement server 100 are transmitted to the vehicle 200, the advertisement contents may be played back through the advertisement playback unit 210 selected from among the plurality of advertisement playback units 210 of the vehicle 200 (S600). The advertisement playback unit 210 may include at least one of display(s) and speaker(s) mounted inside or outside of the vehicle 200.

Particularly, advertisement playback formats may be established in different ways according to the peripheral environment characteristics and advertisement demand classes. For example, when the peripheral environment information indicates a large outdoor parking zone such as a parking lot of a baseball stadium, the advertisement contents may be implemented in a group advertisement format implemented using several vehicles 200. When the peripheral environment information indicates an outdoor parking zone of the airport, the advertisement contents may be displayed on the sunroof displays or window displays of the parked vehicles. In a parking zone located in the vicinity of a one-way street (road) that experiences a high volume of visitors, such as Yeouido cherry blossom walkway, playback of a plurality of advertisement contents may be sequentially repeated by many vehicles parked in the parking zone.

After the vehicle 200 plays back the advertisement contents as described above (S600), the advertisement server 100 may be configured to calculate a usage fee of the advertisement contents (S700). The usage fee of the advertisement contents may be calculated based on a predetermined reference in consideration of an advertisement playback time and the like. When the advertisement usage fee is calculated (S700), the calculated advertisement usage fee may be paid as the parking fee of the vehicle 200 having been used for advertisement playback (S800), or may be paid to the owner (user) of the vehicle 200 (S900). For example, when the advertisement usage fee is greater than the parking fee of the vehicle 200, the balance of the paid parking fee may be sent to an account of the owner of the vehicle 200.

The advertisement system using the vehicle and the advertisement method using the same according to the exemplary embodiments of the present invention may use at least one vehicle parked in the parking zones for advertisement purposes, and may provide economical profits, such that the advertisement usage fee may be used for payment of the parking fee. The advertisers may extend the advertisement range of their advertisement contents to parking zones that experiences a high volume of visitors, such that the advertisers may generate revenue using a substantial number of vehicles parked in the parking zones, and the users of the parked vehicles may also obtain economical profits due to reduction of the parking fee.

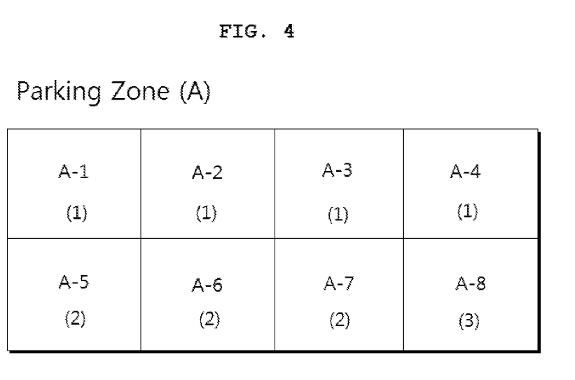

FIG. 4 is a flowchart illustrating an advertisement method using a vehicle according to a second exemplary embodiment of the present invention. For convenience of description and better understanding of the present invention, steps of the advertisement method shown in FIG. 4 will be written from the viewpoint of the advertisers. Referring to FIG. 4, a zone (hereinafter referred to as a parking advertisement zone) to be used for advertisement during the parking time of the vehicle may be divided into a plurality of parking sub-zones (S10). The parking advertisement zone may be selected from among large parking lots having a substantial number of vehicles parked therein. The advertisers may participate in auction bidding for advertisement according to individual parking sub-zones (S20).

The advertisement agency company may update information regarding advertisement available parking zones and associated advertisement contents, may provide the updated information to advertisers, and may thus guide the advertisers to participate in auction bidding for advertisement. After completion of the bidding step S20, advertisement contents classified according to individual zones and peripheral environment characteristics may be allocated to the advertisers (S30).

The advertisement contents may be stored in the advertisement server (S40). The advertisement server may be configured to store the advertisement contents received from the advertisers in the database (DB). When the owner of the vehicle selects the advertisement playback function in the parking zone in which the vehicle is parked, the advertisement contents may be selected from among the plurality of advertisement contents according to the parked zone (S50).

Subsequently, the selected advertisement contents may be transmitted to the parked vehicle, and may then be played back through the display, speaker, and the like of the parked vehicle (S60). When playback of the advertisement contents is completed, the advertisement server may be configured to calculate the usage fee of the advertisement contents and perform payment of the parking fee when the vehicle arrives at an exit of the parking zone (S70).

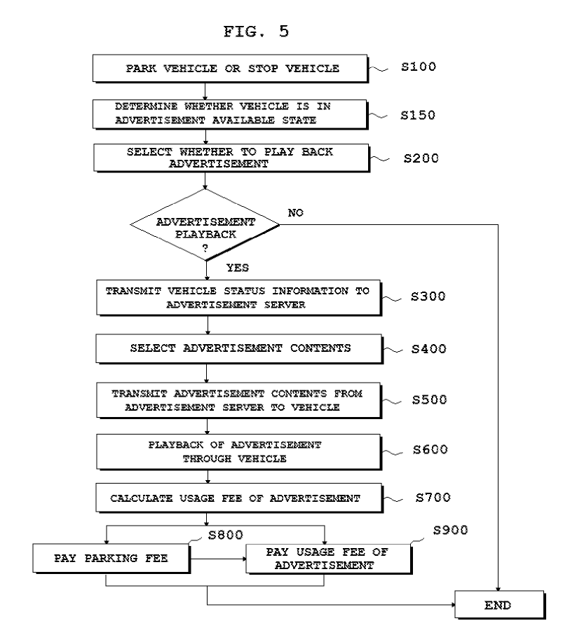

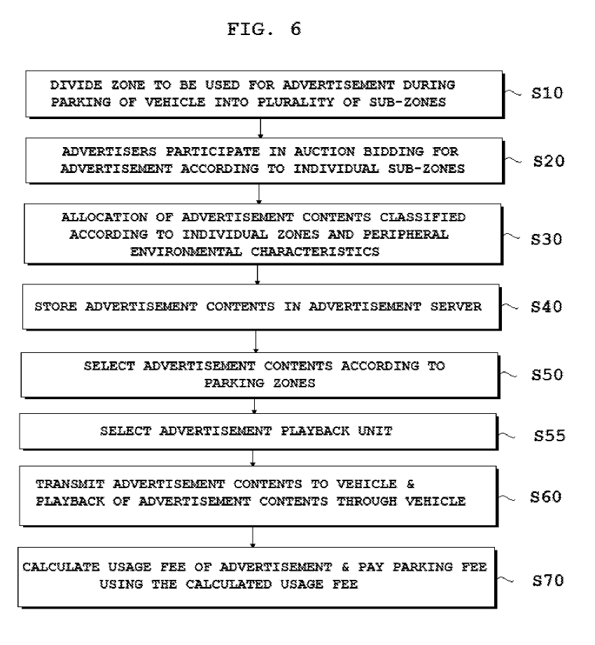

FIG. 5 is a flowchart illustrating an advertisement method using a vehicle according to a third exemplary embodiment of the present invention. FIG. 6 is a flowchart illustrating an advertisement method using a vehicle according to a fourth exemplary embodiment of the present invention. For convenience of description, the third and fourth exemplary embodiments of FIGS. 5 and 6 will be described centering on unique parts different from those of the above-mentioned exemplary embodiments.

Referring to FIG. 5, the advertisement method according to the third exemplary embodiment may include allowing a vehicle to park or stop in the parking zone (S100) and determining whether the parked vehicle may be used for advertisement (S150). In the step S150 for determining whether the parked vehicle may be used for advertisement, when the vehicle is in at least one of a first state in which a gearshift lever of the vehicle is located in a parking mode (P) and a second state in which the vehicle temporarily stops for a predetermined period of time or longer, the advertisement server may be configured to determine that the vehicle may be used for advertisement (i.e., an advertisement available state). In other words, when the driver of the vehicle adjusts the gearshift lever to the parking mode (P), the vehicle may be determined to currently be in the advertisement available state. The step S200 of selecting whether to play back the advertisement contents may be automatically performed or may be manually performed by selection of the driver.

Even when the vehicle temporarily stops for at least a predetermined time and the gearshift lever of the vehicle is located in a neutral mode (N) instead of the parking mode (P), the vehicle may be determined to currently be in the advertisement available state, the step S200 of selecting whether to play back the advertisement contents may be automatically performed or may be manually performed by selection of the driver. The above-mentioned exemplary embodiments are disclosed merely for illustrative purposes, and the step of determining the advertisement available state may be modified in various ways according to various setting states.

Referring to FIG. 6, according to the fourth exemplary embodiment, when the owner (user) of the vehicle selects the advertisement playback function in the parking zone of the vehicle, the step S50 for selecting the advertisement contents according to the parking zones may be performed, and the step S55 for selecting the advertisement playback unit 210 of the vehicle to be used for playback of the selected advertisement contents is then performed.

The step S55 may be performed through the advertisement selection unit 120 of the above-mentioned system. The advertisement selection unit 120 may be configured to select at least one of the advertisement playback units 210 of the vehicle to be used for playback of the advertisement contents and transmit the selected information to the advertisement transceiver 130. For example, the advertisement selection unit 120 may be configured to determine to play back the advertisement contents using the AVN display from among the advertisement playback units 210 or determine to play back the advertisement contents using the vehicle sunroof from among the advertisement playback units 210, and then transmit the determined advertisement contents to the advertisement transceiver 130.

Subsequently, the selected advertisement contents may be transmitted to the vehicle and thus, the selected advertisement contents may be played back by the advertisement playback unit 210 (S60). When playback of the advertisement contents is completed, the advertisement server may be configured to calculate the usage fee of the advertisement contents and perform payment of the parking fee when the vehicle arrives at an exit of the parking zone (S70).

As described above, the advertisement system using the vehicle and the advertisement method using the same may use the parked vehicle for advertisement purposes, and may provide economical profits, to allow the advertisement usage fee to be used as payment of the parking fee or the like. The advertisers may extend the advertisement range of their advertisement contents to large parking zones that experience a substantial amount of visitors, such that the advertisers may generate revenue using a substantial number of vehicles parked in the parking zones, and the users of the parked vehicles may also obtain economical profits due to reduction of the parking fee.

Features, structures, effects, and the like as described above in the exemplary embodiments are included in at least one exemplary embodiment of the present invention and should not be limited to only one exemplary embodiment. In addition, the features, structures, effects, and the like described in the respective exemplary embodiments may be combined or modified even with respect to the other exemplary embodiments by those skilled in the art. Accordingly, contents related to these combinations and modifications should be construed as within the scope of the present invention.

As is apparent from the above description, the advertisement system using the vehicle and the advertisement method using the same according to the exemplary embodiments of the present invention may allow a parked vehicle to be used for advertisement desired by advertisers, such that the advertisers may generate revenue, and a user of the parked vehicle may receive a usage fee caused by advertisement and may use the received usage fee as payment for a parking fee assessed to the parked vehicle.

The advertisers may extend the advertisement range of their advertisement contents to parking zones that experience a substantial amount of visitors, such that the advertisers may generate revenue using a substantial number of vehicles parked in the parking zones, and the users of the parked vehicles may obtain economical profits due to reduction of the parking fee.

It will be apparent to those skilled in the art that various modifications and variations may be made in the present invention without departing from the spirit or scope of the invention. Therefore, the above-mentioned detailed description must be considered only for illustrative purposes instead of restrictive purposes. The scope of the present invention must be decided by a rational analysis of the claims, and all modifications within equivalent ranges of the present invention are within the scope of the present invention.

What is claimed is:

1. An advertisement system using a vehicle, comprising:
an advertisement server configured to store advertisement contents regarding a plurality of advertisers;
at least one advertisement playback unit mounted to a vehicle and configured to play back the advertisement contents; and
an advertisement controller configured to receive the advertisement contents from the advertisement server by communicating with the advertisement server, and control the received advertisement contents to be played back through the advertisement playback unit,
wherein during parking of the vehicle, the advertisement contents supplied from the advertisement server are played back through the advertisement playback unit mounted to the vehicle.

2. The advertisement system according to claim 1, wherein the advertisement server includes:
a database (DB) configured to store the advertisement contents;
an advertisement selection unit configured to select particular advertisement contents from among the advertisement contents stored in the database (DB); and
an advertisement transceiver configured to transmit the advertisement contents selected by the advertisement selection unit by communicating with the advertisement controller.

3. The advertisement system according to claim 2, wherein the advertisement server further includes:
a fee calculation unit configured to calculate a fee for the advertisement contents transmitted by the advertisement transceiver.

4. The advertisement system according to claim 3, wherein the fee calculation unit is configured to calculate a usage fee of the advertisement contents and pay the calculated usage fee as a parking fee of the vehicle when the vehicle arrives at an exit of a parking region.

5. The advertisement system according to claim 3, wherein the fee calculation unit is configured to calculate a usage fee of the advertisement contents and pay the calculated usage fee to an owner of the vehicle.

6. The advertisement system according to claim 5, wherein the advertisement selection unit is configured to select, from among a plurality of advertisement contents allocated according to peripheral environment characteristics and advertisement demand class information, a few advertisement contents allocated to a region in which the parked vehicle is located, and transmit the selected advertisement contents to the advertisement transceiver.

7. The advertisement system according to claim 6, wherein the advertisement selection unit is configured to select at least one of the advertisement playback units to be used for playback of the selected advertisement contents and transmit information indicating the selected advertisement playback unit to the advertisement transceiver.

8. The advertisement system according to claim 5, wherein the advertisement playback unit includes at least one of a display, a light, and a speaker installed inside or outside of the vehicle.

9. The advertisement system according to claim 8, wherein the display is mounted to at least one of a sunroof, a sun visor, an audio video navigation (AVN), a cluster, a windshield, a door, and a window of the vehicle.

10. The advertisement system according to claim 5, wherein the advertisement server is provided with advertisement contents from advertisers using a bidding system, and advertisement contents classified according to individual regions or peripheral environment characteristics are provided to the advertisers by the advertisement server.

11. The advertisement system according to claim 5, wherein the advertisement controller is configured to transmit vehicle status information, which includes at least one selected from the group consisting of: a current position of the vehicle, peripheral point of interest (POI) information, peripheral vehicle information, a current time, a battery charge, and an estimated re-driving time, to the advertisement server.

12. An advertisement method using a vehicle, comprising:
selecting, by a controller, whether to play back advertisement in response to the vehicle being parked;
when the playback of the advertisement is selected, transmitting, by the controller, status information of the vehicle to an advertisement server;
receiving, by the controller, stored advertisement from the advertisement server; and
playing back, by the controller, the advertisement through the vehicle.

13. The advertisement method according to claim 12, wherein the status information of the vehicle includes at least one selected from the group consisting of: a current position of the vehicle, peripheral point of interest (POI) information, peripheral vehicle information, a current time, a battery charge, and an estimated re-driving time of the vehicle.

14. The advertisement method according to claim 13, further comprising:
after parking the vehicle, determining, by the controller, whether the parked vehicle is in an advertisement available state in which the advertisement is executable through the parked vehicle.

15. The advertisement method according to claim 14, wherein the determining of whether the parked vehicle is in the advertisement available state includes:
when the vehicle is in at least one of a first state in which a gearshift lever of the vehicle is located in a parking mode (P) and a second state in which the vehicle stops for a predetermined period of time or longer, determining, by the controller, that the parked vehicle is in the advertisement available state.

16. The advertisement method according to claim 15, further comprising:
before receiving the advertisement at the vehicle an advertisement to be transmitted from the advertisement server to the vehicle is selected.

17. The advertisement method according to claim 16, wherein the playing back of the advertisement through the vehicle includes:
playing back, by the controller, the advertisement through at least one of a display, a light, and a speaker installed inside or outside of the vehicle.

18. The advertisement method according to claim 18, wherein the advertisement server includes advertisement contents supplied from a plurality of advertisers.

19. The advertisement method according to claim 18, wherein the advertisement server is provided with advertisement contents by the advertisers using a bidding system and advertisement contents allocated for each region according to peripheral environment characteristics and advertisement demand class information is transmitted to the advertisers.

20. The advertisement method according to claim 17, further comprising:
after playing back the advertisement through the vehicle, paying, by the controller, an advertisement usage fee caused by playback of the advertisement to an owner of the vehicle.

21. The advertisement method according to claim 20, wherein the advertisement usage fee is used as a parking fee of the vehicle.

22. An advertisement method using a vehicle, comprising:
dividing, by a server controller, a region to be used for advertisement in a parking state of the vehicle into a plurality of sub-regions;
allowing, by the server controller, a plurality of advertisers to participate in auction bidding for advertisement based on the respective sub-regions;
allocating, by the server controller, advertisement contents classified based on the respective sub-regions or peripheral environment characteristics to advertisers acting as successful bidders; and
transmitting, by the server controller, the advertisement contents to the vehicle to play back the transmitted advertisement contents through the vehicle.

23. The advertisement method according to claim 22, further comprising:
storing, by the server controller, successfully sold advertisement contents in an advertisement server.

24. The advertisement method according to claim 22, further comprising:
selecting, by the server controller, an advertisement playback unit of the vehicle.

25. The advertisement method according to claim 22, further comprising:
when the playback of the advertisement is completed, calculating, by the server controller, a usage fee of the advertisement to pay a parking fee of the vehicle using the advertisement usage fee when the vehicle arrives at an exit of the parked region.

26. The advertisement method according to claim 22, further comprising:
selecting, by the server controller, from among the advertisement contents supplied from the plurality of advertisers, a few advertisement contents allocated to sub-regions in which the parked vehicle is located.
